(19) United States
(12) Patent Application Publication
(10) Pub. No.: US 2026/0010191 A1
(43) Pub. Date: Jan. 8, 2026

(54) SPLIT-TYPE ELECTROMAGNETIC INDUCTION JOYSTICK POTENTIOMETER

(71) Applicant: Guangdong Jinfu Intelligent Technology Co., Ltd, Dongguan (CN)

(72) Inventors: Guosheng ZENG, Dongguan (CN); Chengteng LIANG, Dongguan (CN); Shengkai HUANG, Dongguan (CN)

(21) Appl. No.: 19/182,644

(22) Filed: Apr. 18, 2025

(30) Foreign Application Priority Data
Jul. 2, 2024 (CN) 202421544072.8
Feb. 19, 2025 (CN) 202510184828.5

(51) Int. Cl. G05G 9/047; H01C 10/00

(52) U.S. Cl. CPC G05G 9/04785; H01C 10/00

(57) ABSTRACT

A split-type electromagnetic induction joystick potentiometer includes a handle circuit board provided with at least one joystick mechanism installation position and at least one joystick mechanism installed on the at least one joystick mechanism installation position. Each joystick mechanism installation position is welded with a magnetic induction chip. Each joystick mechanism includes a base, a sliding disc, a spring, a joystick, a rocker arm, an upper cover and a housing. The magnetic induction chip is directly welded onto the handle circuit board, without the need for separate design and manufacturing of a magnetic induction circuit board to weld the magnetic induction chip. Each joystick mechanism of the disclosure itself is not installed with the magnetic induction circuit board, thereby simplifying the manufacturing and assembly process of the split-type electromagnetic induction joystick potentiometer, and reducing the manufacturing costs. The permanent magnet can interact magnetically with the magnetic induction chip.

### TECHNICAL FIELD

The disclosure relates to the technical field of potentiometers, and more particularly to a split-type electromagnetic induction joystick potentiometer.

### BACKGROUND

A joystick potentiometer is a variable potentiometer suitable for a joystick control handle in devices such as game consoles and drones. By manipulating joysticks, the joystick potentiometer controls state changes of internal components in the devices.

Referring to a Chinese patent literature with publication No. CN222190385U, in the related art, an electromagnetic induction joystick potentiometer generally includes: a joystick mechanism assembly and a magnetic induction circuit board, which are integrated structures, i.e., the magnetic induction circuit board is installed inside the joystick mechanism assembly, thereby forming a single unit. The joystick mechanism assembly is provided with a permanent magnet, and the magnetic induction circuit board is provided with a magnetic induction chip (e.g., a Hall chip). The permanent magnet and the magnetic induction chip interact magnetically. Under the action of the joystick mechanism assembly, the permanent magnet can be moved, and during this process, the magnetic induction chip can detect changes in the magnetic field of the permanent magnet and output corresponding electrical signals.

However, the integrated electromagnetic induction joystick potentiometer still has the following technical issues. When manufacturers produce a joystick control handle, they need to design both a handle circuit board and the magnetic induction circuit board. The magnetic induction chip and other related electronic components cannot be welded onto the handle circuit board by using the surface-mount technology (SMT) process. Instead, the magnetic induction circuit board must be independently manufactured, and the magnetic induction chip and other electronic components must be welded onto the magnetic induction circuit board by using the SMT process. On one hand, the manufacturers need to design and manufacture two types of circuit boards, i.e., the handle circuit board and the magnetic induction circuit board, which leads to higher manufacturing costs. On the other hand, the assembly and testing process of installing the magnetic induction circuit board into the joystick mechanism assembly is relatively complicated, and the costs associated with assembly and testing are also relatively high.

### SUMMARY

In response to above shortcomings of the related art, the disclosure provides a split-type electromagnetic induction joystick potentiometer. The split-type electromagnetic induction joystick potentiometer includes a handle circuit board and a joystick mechanism manufactured separately. A magnetic induction chip is directly welded onto the handle circuit board. The magnetic induction chip and other electronic components can be welded through the SMT process during the manufacturing of the handle circuit board, without the need for separate design and manufacturing of a magnetic induction circuit board to weld the magnetic induction chip. The joystick mechanism itself is not installed with the magnetic induction circuit board, thereby simplifying the manufacturing and assembly process of the split-type electromagnetic induction joystick potentiometer, and reducing the manufacturing costs. The permanent magnet of the joystick mechanism can interact magnetically with the magnetic induction chip on the handle circuit board, thus making the magnetic induction chip on the handle circuit board sense changes in magnetic field strength and output induction signals.

A first technical solution of the disclosure is a split-type electromagnetic induction joystick potentiometer, including a handle circuit board and at least one joystick mechanism.

The handle circuit board is provided with at least one joystick mechanism installation position. Each of the at least one joystick mechanism installation position is welded with a magnetic induction chip.

The at least one joystick mechanism is installed on the at least one joystick mechanism installation position respectively. Each of the at least one joystick mechanism includes a base, a sliding disc, a spring, a joystick, a rocker arm, an upper cover and a housing. The base defines a cavity, the sliding disc is installed in a liftable manner inside the cavity, the base is provided with a cavity spring seat on an outer periphery of the cavity, and a lower side of the sliding disc is provided with a sliding disc spring seat. A lower end of the spring is installed on the cavity spring seat, and an upper end of the spring is installed under the sliding disc spring seat. The base is connected to guide pins on sides of the cavity, walls of the guide pins facing towards the cavity define guide grooves respectively, sides of the sliding disc are connected to guide strips, and the guide strips correspond to and are in sliding fit with the guide grooves respectively. The joystick is installed on the sliding disc, a lower end of the joystick is installed with a permanent magnet, and the permanent magnet interacts magnetically with the magnetic induction chip. The upper cover is installed on the base, the rocker arm is installed inside the upper cover, and the joystick passes through the upper cover and is connected to the rocker arm. The housing is installed outside the base and the upper cover, a lower end of the housing is connected to the base and the handle circuit board individually, and an upper end of the housing is connected to the upper cover.

In an embodiment, an outside wall of the upper cover is provided with multiple latch blocks, a side of the housing defines multiple latch grooves corresponding to the latch blocks respectively, and the latch grooves are in snap fit with the latch blocks respectively. The lower end of the housing is provided with multiple locking tabs bent inwardly and multiple connecting pins extending downwardly, and the locking tabs are attached onto the lower side of the base and are hooked onto the base. Each of the at least one joystick mechanism installation position defines multiple inserting holes, and the connecting pins of the housing are inserted into and connected to the inserting holes correspondingly.

In an embodiment, the housing is a metal housing, a lower end of the base is provided with multiple positioning columns, each of the at least one joystick mechanism installation position defines multiple positioning holes, and the positioning columns are inserted into and connected to the positioning holes respectively.

In an embodiment, the rocker arm includes a rocker arm body and rocker arm pivot shafts. The rocker arm pivot shafts are connected to two ends of the rocker arm body and are rotatably connected to an inner wall of the upper cover, a lower end of one of the rocker arm pivot shafts is provided with a pressure block, each of the at least one joystick mechanism installation position is provided with a dome switch, and the pressure block is in pressing engagement with the dome switch. A central part of the rocker arm body defines a rocker arm central hole allowing the joystick to pass therethrough, and an inner wall of the rocker arm body surrounding the rocker arm central hole is rotatably connected to the joystick. An end of the base defines a pressure block through hole penetrating up and down, and the pressure block extends downwardly into the pressure block through hole.

In an embodiment, the sliding disc defines a sliding disc central hole, the lower end of the joystick passes through the sliding disc central hole, the base defines a cavity central hole at a central part of the cavity, the sliding disc central hole is vertically opposite to the cavity central hole, an inner cover body is integrally formed and connected to the base inside the cavity central hole, a lower end of the inner cover body defines a chip accommodation groove, and an upper end of the magnetic induction chip is accommodated inside the chip accommodation groove.

A second technical solution of the disclosure is: a split-type electromagnetic induction joystick potentiometer, including: a handle circuit board, and at least one joystick mechanism.

The handle circuit board is provided with at least one joystick mechanism installation position. Each of the at least one joystick mechanism installation position is welded with a first magnetic induction chip and a second magnetic chip.

The at least one joystick mechanism is installed on the at least one joystick mechanism installation position respectively. Each of the at least one joystick mechanism includes a base, a sliding disc, a spring, a joystick, an upper rocker arm, a lower rocker arm, an upper cover and a housing.

The base defines a cavity, the sliding disc is installed in a liftable manner inside the cavity, the base is provided with a cavity spring seat on an outer periphery of the cavity, and a lower side of the sliding disc is provided with a sliding disc spring seat. A lower end of the spring is installed on the cavity spring seat, and an upper end of the spring is installed under the sliding disc spring seat. The base is connected to guide pins on sides of the cavity, walls of the guide pins facing towards the cavity define guide grooves respectively, sides of the sliding disc are connected to guide strips, and the guide strips correspond to and are in sliding fit with the guide grooves respectively. The joystick is installed on the sliding disc. The upper cover is installed on the base. The upper rocker arm and the lower rocker arm are installed inside the upper cover sequentially in that order from top to bottom, and the joystick passes through the upper cover and is connected to the upper rocker arm and the lower rocker arm. The base defines a first through hole and a second through hole penetrating up and down, an end of the upper rocker arm is provided with a first permanent magnet, an upper end of the first magnetic induction chip extends into the first through hole, and the first permanent magnet interacts magnetically with the first magnetic induction chip. An end of the lower rocker arm is provided with a second permanent magnet, an upper end of the second magnetic induction chip extends into the second through hole, and the second permanent magnet interacts magnetically with the second magnetic induction chip. The housing is installed outside the base and the upper cover, a lower end of the housing is connected to the base and the handle circuit board individually, and an upper end of the housing is connected to the upper cover.

In an embodiment, an outside wall of the upper cover is provided with multiple latch blocks, a side of the housing defines multiple latch grooves corresponding to the latch blocks respectively, and the latch grooves are in snap fit with the latch blocks respectively. The lower end of the housing is provided with multiple locking tabs bent inwardly and multiple connecting pins extending downwardly, and the locking tabs are attached onto the lower side of the base and are hooked onto the base. Each of the at least one joystick mechanism installation position defines multiple inserting holes, and the connecting pins of the housing are inserted into and connected to the inserting holes correspondingly.

In an embodiment, the housing is a metal housing, a lower end of the base is provided with multiple positioning columns, each of the at least one joystick mechanism installation position defines multiple positioning holes, and the positioning columns are inserted into and connected to the positioning holes respectively.

In an embodiment, the upper rocker arm includes an upper rocker arm body and upper rocker arm pivot shafts. The upper rocker arm pivot shafts are connected to two ends of the upper rocker arm body and are rotatably connected to an inner wall of the upper cover, a central part of the upper rocker arm body defines an upper rocker arm central hole which allows the joystick to pass therethrough movably, a lower end of one of the upper rocker arm pivot shafts is provided with a first magnet positioning block, and the first permanent magnet is installed in the first magnet positioning block and is vertically opposite to the first magnetic induction chip.

In an embodiment, the lower rocker arm includes a lower rocker arm body and lower rocker arm pivot shafts. The lower rocker arm pivot shafts are connected to two ends of the lower rocker arm body and are rotatably connected to the inner wall of the upper cover. A central part of the lower rocker arm body defines a lower rocker arm central hole which allows the joystick to pass therethrough movably, and an inner wall of the lower rocker arm body surrounding the lower rocker arm central hole is rotatably connected to the joystick. A lower end of one of the lower rocker arm pivot shafts is provided with a second magnet positioning block, and the second permanent magnet is installed in the second magnet positioning block and is vertically opposite to the second magnetic induction chip. A lower end of another one of the lower rocker arm pivot shafts is provided with a pressure block, each of the at least one joystick mechanism installation position is provided with a dome switch, and the pressure block is in pressing engagement with the dome switch. An end of the base defines a pressure block through hole penetrating up and down, and the pressure block extends downwardly into the pressure block through hole.

The disclosure has the following beneficial effects. The disclosure includes the handle circuit board and the joystick mechanism which are manufactured separately. The magnetic induction chip is directly welded onto the handle circuit board. The magnetic induction chip and other electronic components can be welded through the SMT process during the manufacturing of the handle circuit board, without the need for separate design and manufacturing of a magnetic induction circuit board to weld the magnetic induction chip. The joystick mechanism of the disclosure itself is not installed with the magnetic induction circuit board, thereby simplifying the manufacturing and assembly process of the split-type electromagnetic induction joystick potentiometer, and reducing the manufacturing costs. When manufacturers produce joystick handles, there is no need to design and manufacture a magnetic induction circuit board, and the manufacturers only need design and manufacture the handle circuit board with the magnetic induction chip. When each joystick mechanism is connected and fixed to the handle circuit board with the magnetic induction chip, each joystick mechanism and the magnetic induction chip on the handle circuit board can form the magnetic induction fit and be combined to form a complete magnetic induction joystick potentiometer. The housing of the joystick mechanism of the disclosure can fix the base to the upper cover, and can fix the joystick mechanism of the disclosure on the handle circuit board. In the first technical solution of the disclosure, the permanent magnet can interact magnetically with the magnetic induction chip on the handle circuit board, thus making the magnetic induction chip on the handle circuit board sense changes in magnetic field strength and output induction signals during the process of moving the joystick. In the second technical solution of the disclosure, the first permanent magnet and the second permanent magnet can interact magnetically with the first magnetic induction chip and the second magnetic induction chip on the handle circuit board, thus making the first magnetic induction chip and the second magnetic induction chip on the handle circuit board sense changes in magnetic field strength and output induction signals during the process of moving the joystick.

### BRIEF DESCRIPTION OF DRAWINGS

FIG. 1 illustrates a schematic diagram of an overall structure of a joystick potentiometer according to an embodiment 1 of the disclosure.

FIG. 2 illustrates a schematic structural diagram of a handle circuit board and joystick mechanisms in a separate state according to the embodiment 1 of the disclosure.

FIG. 3 illustrates a schematic structural diagram of a joystick mechanism from a first perspective according to the embodiment 1 of the disclosure.

FIG. 4 illustrates a schematic structural diagram of the joystick mechanism from a second perspective according to the embodiment 1 of the disclosure.

FIG. 5 illustrates an exploded view of the joystick mechanism and the handle circuit board from a first perspective according to the embodiment 1 of the disclosure.

FIG. 6 illustrates an exploded view of the joystick mechanism and the handle circuit board from a second perspective according to the embodiment 1 of the disclosure.

FIG. 7 illustrates a schematic diagram of an overall structure of a joystick potentiometer according to an embodiment 2 of the disclosure.

FIG. 8 illustrates a schematic structural diagram of a handle circuit board and joystick mechanisms in a separate state according to the embodiment 2 of the disclosure.

FIG. 9 illustrates a schematic structural diagram of a joystick mechanism from a first perspective according to the embodiment 2 of the disclosure.

FIG. 10 illustrates a schematic structural diagram of the joystick mechanism from a second perspective according to the embodiment 2 of the disclosure.

FIG. 11 illustrates an exploded view of the joystick mechanism and the handle circuit board from a first perspective according to the embodiment 2 of the disclosure.

FIG. 12 illustrates an exploded view of the joystick mechanism and the handle circuit board from a second perspective according to the embodiment 2 of the disclosure.

### DETAILED DESCRIPTION OF EMBODIMENTS

The structural and working principles of the disclosure will be further explained in detail below with reference to the accompanying drawings.

### Embodiment 1

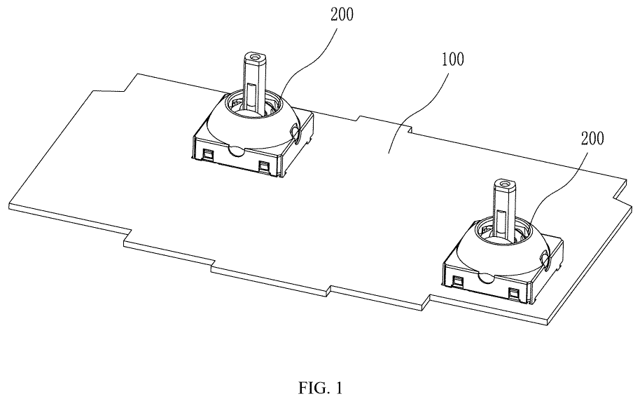

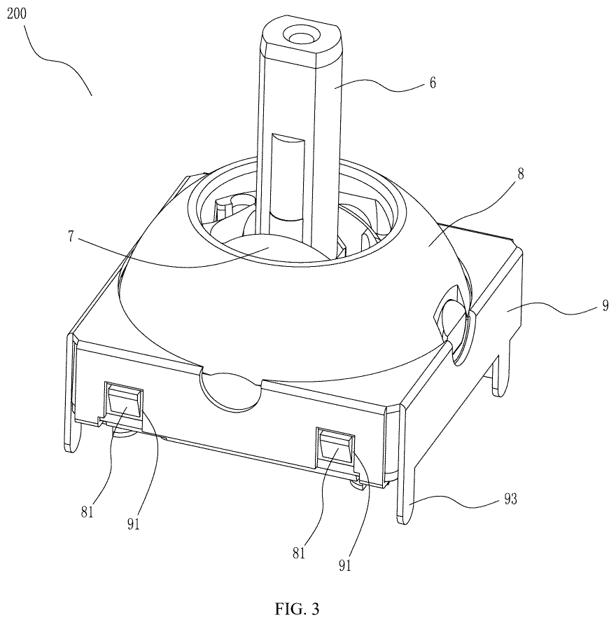

As shown in FIG. 1 to FIG. 6, an embodiment of the disclosure provides a split-type electromagnetic induction joystick potentiometer, including: a handle circuit board 100 and at least one joystick mechanism 200.

The handle circuit board 100 is a main control circuit board in a joystick control handle for gaming consoles, drones, and other devices. The handle circuit board 100 is provided with at least one joystick mechanism installation position 1. Each of the at least one joystick mechanism installation position 1 is welded with a magnetic induction chip 2. In the embodiment, the handle circuit board 100 is provided with two joystick mechanism installation positions 1.

In the embodiment, a number of the at least one joystick mechanism 200 is two, to meet the left and right hand usage need of users. The joystick mechanisms 200 are installed on the joystick mechanism installation positions 1 respectively. Each joystick mechanism 200 includes a base 3, a sliding disc 4, a spring 5, a joystick 6, a rocker arm 7, an upper cover 8 and a housing 9. The base 3 defines a cavity 31, the sliding disc 4 is installed in a liftable manner inside the cavity 31, the base 3 is provided with a cavity spring seat 32 on an outer periphery of the cavity 31, and a lower side of the sliding disc 4 is provided with a sliding disc spring seat 41. A lower end of the spring 5 is installed on the cavity spring seat 32, and an upper end of the spring 5 is installed under the sliding disc spring seat 41. The base 3 is connected to four guide pins 33 on sides of the cavity 31, walls of the guide pins 33 facing towards the cavity 31 define guide grooves 34 respectively, sides of the sliding disc 4 are connected to guide strips 42, and the guide strips 42 correspond to and are in sliding fit with the guide grooves 34 respectively. The joystick 6 is installed on the sliding disc 4, a lower end of the joystick 6 is installed with a permanent magnet 10, and the permanent magnet 10 interacts magnetically with the magnetic induction chip 2. The upper cover 8 is installed on the base 3, the rocker arm 7 is installed inside the upper cover 8, and the joystick 6 passes through the upper cover 8 and is connected to the rocker arm 7. The housing 9 is installed outside the base and the upper cover 8, a lower end of the housing 9 is connected to the base 3 and the handle circuit board 100 individually, and an upper end of the housing 9 is connected to the upper cover 8. When moving the joystick 6, the joystick 6 can push the sliding disc 4 to overcome the elastic force of the spring 5 to move downward. When releasing the joystick 6, the spring 5 pushes the sliding disc 4 upward, and the sliding disc 4 then pushes the joystick 6 back to its original central position.

The split-type electromagnetic induction joystick potentiometer includes the handle circuit board 100 and the joystick mechanisms 200 manufactured separately. The handle circuit board 100 and the joystick mechanisms 200 are manufactured and formed individually. The magnetic induction chip 2 is directly welded on the handle circuit board 100, and thus the magnetic induction chip 2 and other electronic components can be welded through the SMT process during the manufacturing of the handle circuit board 100, without the need for separate design and manufacturing of a magnetic induction circuit board to weld the magnetic induction chip 2. The joystick mechanisms 200 themselves are not installed with the magnetic induction circuit board, thereby simplifying the manufacturing and assembly process of the split-type electromagnetic induction joystick potentiometer, and reducing the manufacturing costs. When manufacturers produce joystick handles, there is no need to design and manufacture a magnetic induction circuit board, and the manufacturers only need design and manufacture the handle circuit board 100 with the magnetic induction chip 2. When the joystick mechanisms 200 are connected and fixed to the handle circuit board 100 with the magnetic induction chip 2, the joystick mechanisms 200 and the magnetic induction chips 2 on the handle circuit board 100 can form the magnetic induction fit and be combined to form a complete magnetic induction joystick potentiometer. The housing 9 of each joystick mechanism 200 of the disclosure can fix the base 3 to the upper cover 8, and can fix each joystick mechanism 200 of the disclosure on the handle circuit board 100. The permanent magnet 10 can interact magnetically with the magnetic induction chip 2 on the handle circuit board 100, thus making the magnetic induction chip 2 on the handle circuit board 100 sense changes in magnetic field strength and output induction signals during the process of moving the joystick 6.

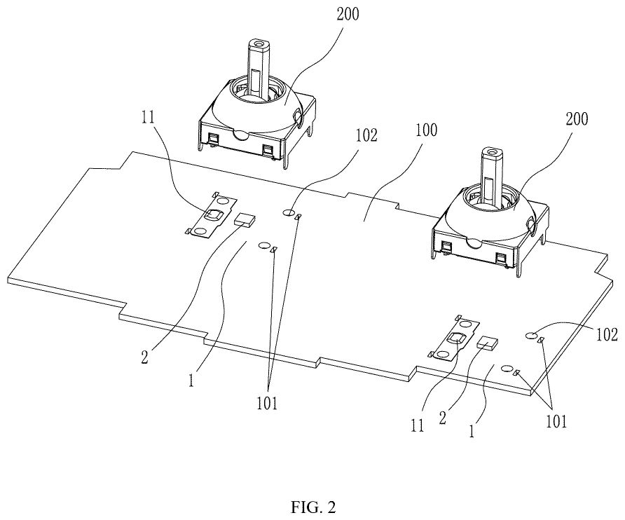

As shown in FIG. 2 to FIG. 6, an outside wall of the upper cover 8 is provided with multiple latch blocks 81, a side of the housing 9 defines multiple latch grooves 91 corresponding to the latch blocks 81 respectively, and the latch grooves 91 are in snap fit with the latch blocks 81 respectively. The lower end of the housing 9 is provided with four locking tabs 92 bent inwardly and four connecting pins 93 extending downwardly, and the locking tabs 92 are attached onto the lower side of the base 3 and are hooked onto the base 3. Each joystick mechanism installation position 1 defines four inserting holes 101, and the connecting pins 93 of the housing 9 are inserted into and connected to the inserting holes 101 correspondingly. Furthermore, the housing 9 is a metal housing, a lower end of the base 3 is provided with four positioning columns 35, each joystick mechanism installation position 1 defines four positioning holes 102, and the positioning columns 35 are inserted into and connected to the positioning holes 102 respectively.

As shown in FIG. 2 to FIG. 6, the rocker arm 7 includes a rocker arm body 71 and rocker arm pivot shafts 72. The rocker arm pivot shafts 72 are connected to two ends of the rocker arm body 71 and are rotatably connected to an inner wall of the upper cover 8, a lower end of one of the rocker arm pivot shafts 72 is provided with a pressure block 73, each joystick mechanism installation position 1 is provided with a dome switch 11, and the pressure block 73 is in pressing engagement with the dome switch 11. A central part of the rocker arm body 71 defines a rocker arm central hole 74 allowing the joystick 6 to pass therethrough, and an inner wall of the rocker arm body 71 surrounding the rocker arm central hole 74 is rotatably connected to the joystick 6. An end of the base 3 defines a pressure block through hole 36 penetrating up and down, and the pressure block 73 extends downwardly into the pressure block through hole 36. The dome switch 11 is disposed on the handle circuit board 100 through soldering, and can be installed by the SMT process for easy manufacturing. Meanwhile, in the disclosure, there is no need to arrange a circuit board for installing the dome switch 11 in each joystick mechanism 200, significantly simplifying the assembly and manufacturing process of the joystick mechanisms 200.

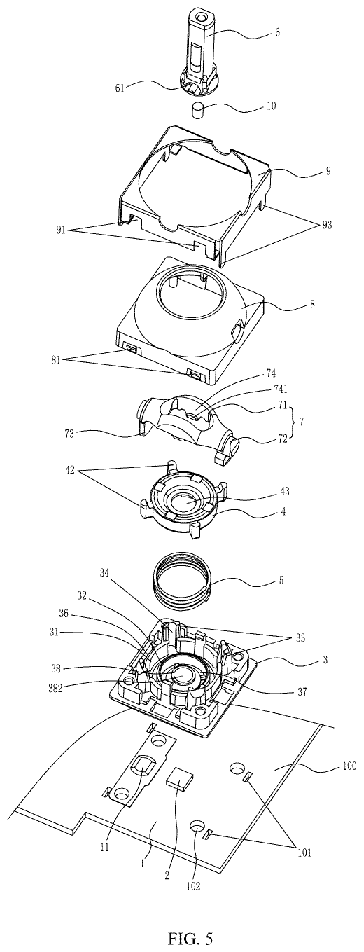

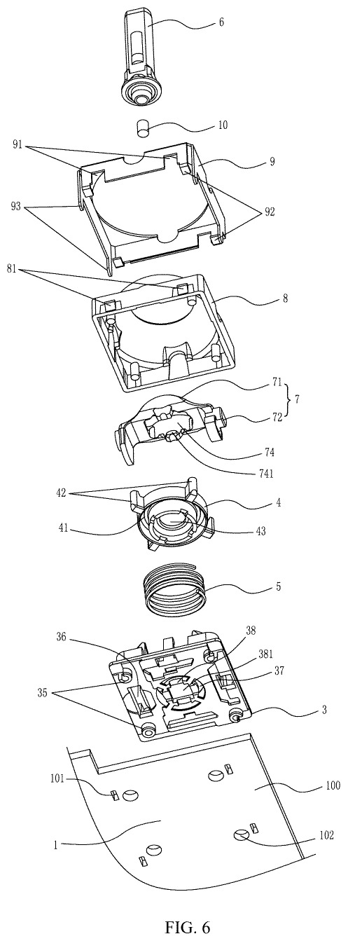

As shown in FIG. 5 and FIG. 6, the inner wall of the rocker arm body 71 surrounding the rocker arm central hole 74 is provided with a locking block 741, a side wall of the lower end of the joystick 6 defines a locking hole 61, and the locking block 741 is rotatably engaged with the locking hole 61.

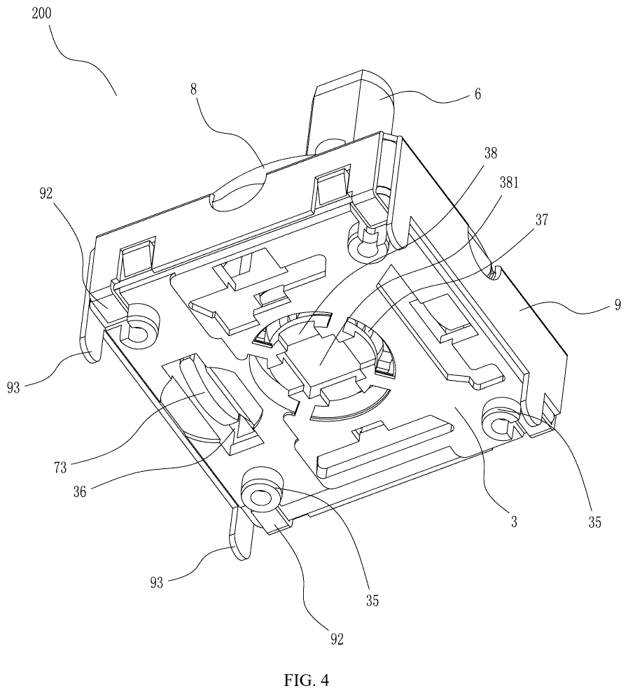

As shown in FIG. 4 to FIG. 6, the sliding disc 4 defines a sliding disc central hole 43, the lower end of the joystick 6 passes through the sliding disc central hole 43, the base 3 defines a cavity central hole 37 at a central part of the cavity 31, the sliding disc central hole 43 is vertically opposite to the cavity central hole 37, an inner cover body 38 is integrally connected to the base 3 inside the cavity central hole 37, a lower end of the inner cover body 38 defines a chip accommodation groove 381, and an upper end of the magnetic induction chip 2 is accommodated inside the chip accommodation groove 381. The permanent magnet 10 is a cylindrical permanent magnet, the permanent magnet 10 is vertically opposite to the magnetic induction chip 2, and an upper side of the inner cover body 38 defines a clearance groove 382 which is arc-shaped. Setting the inner cover body 38 can provide protection for the magnetic induction chip 2, and can prevent the bottom of the joystick 6 from damaging the magnetic induction chip 2 during the falling process of the split-type electromagnetic induction joystick potentiometer.

### Embodiment 2

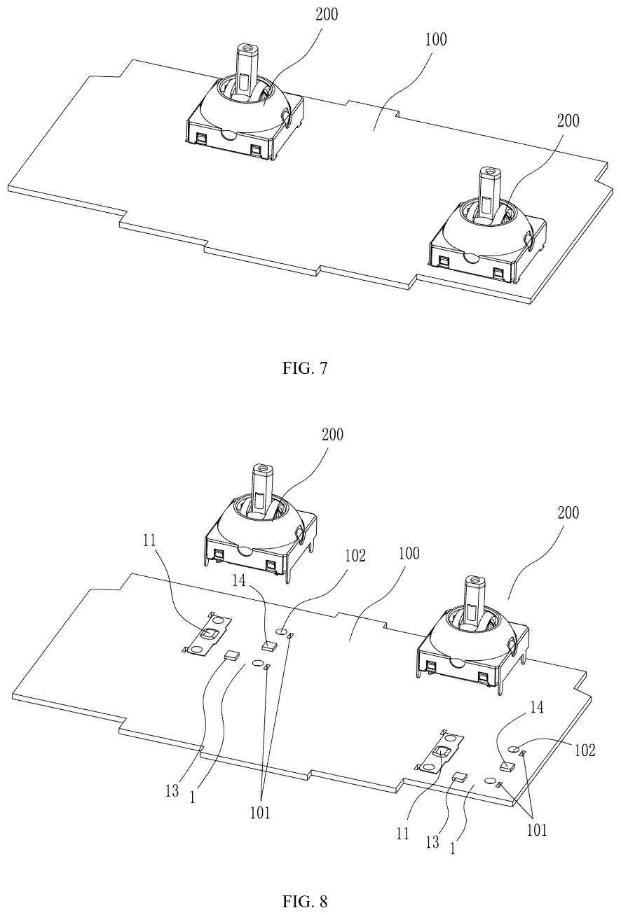

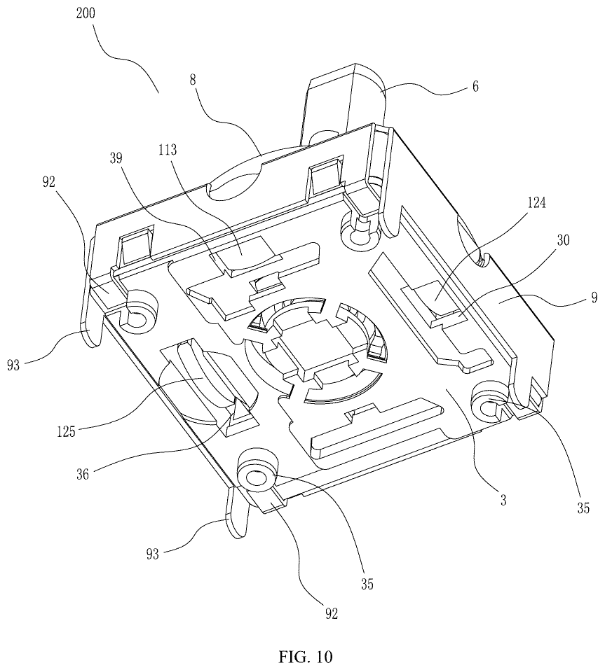

As shown in FIG. 7 to FIG. 12, an embodiment 2 of the disclosure provides a split-type electromagnetic induction joystick potentiometer, including: a handle circuit board 100 and at least one joystick mechanism 200.

The handle circuit board 100 is a main control circuit board in a joystick control handle for gaming consoles, drones, and other devices. The handle circuit board 100 is provided with at least one joystick mechanism installation position 1. Each of the at least one joystick mechanism installation position 1 is welded with a first magnetic induction chip 13 and a second magnetic induction chip 14. In the embodiment, the handle circuit board 100 is provided with two joystick mechanism installation positions 1.

In the embodiment, a number of the at least one joystick mechanism 200 is two, to meet the left and right hand usage need of users. The joystick mechanisms 200 are installed on the joystick mechanism installation positions 1 respectively. Each joystick mechanism 200 includes a base 3, a sliding disc 4, a spring 5, a joystick 6, an upper rocker arm 11, a lower rocker arm 12, an upper cover 8 and a housing 9. The base 3 defines a cavity 31, the sliding disc 4 is installed in a liftable manner inside the cavity 31, the base 3 is provided with a cavity spring seat 32 on an outer periphery of the cavity 31, and a lower side of the sliding disc 4 is provided with a sliding disc spring seat 41. A lower end of the spring 5 is installed on the cavity spring seat 32, and an upper end of the spring 5 is installed under the sliding disc spring seat 41. The base 3 is connected to four guide pins 33 on sides of the cavity 31, walls of the guide pins 33 facing towards the cavity 31 define guide grooves 34 respectively, sides of the sliding disc 4 are connected to guide strips 42, and the guide strips 42 correspond to and are in sliding fit with the guide grooves 34 respectively. The joystick 6 is installed on the sliding disc 4. The upper cover 8 is installed on the base 3. The upper rocker arm 11 and the lower rocker arm 12 are installed inside the upper cover 8 sequentially in that order from top to bottom, and the joystick 6 passes through the upper cover 8 and is connected to the upper rocker arm 11 and the lower rocker arm 12. The base 3 defines a first through hole 39 and a second through hole 30 penetrating up and down, an end of the upper rocker arm 11 is provided with a first permanent magnet 15, the first permanent magnet 15 is vertically opposite to the first through hole 39, an upper end of the first magnetic induction chip 13 extends into the first through hole 39, and the first permanent magnet 15 interacts magnetically with the first magnetic induction chip 13. An end of the lower rocker arm 12 is provided with a second permanent magnet 16, an upper end of the second magnetic induction chip 14 extends into the second through hole 30, and the second permanent magnet 16 interacts magnetically with the second magnetic induction chip 14. The housing 9 is installed outside the base 3 and the upper cover 8, a lower end of the housing 9 is connected to the base 3 and the handle circuit board 100 individually, and an upper end of the housing 9 is connected to the upper cover 8. When moving the joystick 6, the joystick 6 can push the sliding disc 4 to overcome the elastic force of the spring 5 to move downward. When releasing the joystick 6, the spring 5 pushes the sliding disc 4 upward, and the sliding disc 4 then pushes the joystick 6 back to its original central position.

The split-type electromagnetic induction joystick potentiometer includes the handle circuit board 100 and the joystick mechanisms 200 manufactured separately. The handle circuit board 100 and the joystick mechanisms 200 are manufactured and formed individually. The magnetic induction chip 2 is directly welded on the handle circuit board 100, and thus the magnetic induction chip 2 and other electronic components can be welded through the SMT process during the manufacturing of the handle circuit board 100, without the need for separate design and manufacturing of a magnetic induction circuit board to weld the magnetic induction chip 2. The joystick mechanisms 200 themselves are not installed with the magnetic induction circuit board, thereby simplifying the manufacturing and assembly process of the split-type electromagnetic induction joystick potentiometer, and reducing the manufacturing costs. When manufacturers produce joystick handles, there is no need to design and manufacture a magnetic induction circuit board, and the manufacturers only need design and manufacture the handle circuit board 100 with the magnetic induction chip 2. When the joystick mechanisms 200 are connected and fixed to the handle circuit board 100 with the magnetic induction chip 2, the joystick mechanisms 200 and the magnetic induction chips 2 on the handle circuit board 100 can form the magnetic induction fit and be combined to form a complete magnetic induction joystick potentiometer. The housing 9 of each joystick mechanism 200 of the disclosure can fix the base 3 to the upper cover 8, and can fix each joystick mechanism 200 of the disclosure on the handle circuit board 100. The first permanent magnet 15 and the second permanent magnet 16 can interact magnetically with the first magnetic induction chip 13 and the second magnetic induction chip 14 on the handle circuit board 100, thus making the first magnetic induction chip 13 and the second magnetic induction chip 14 on the handle circuit board 100 sense changes in magnetic field strength and output induction signals.

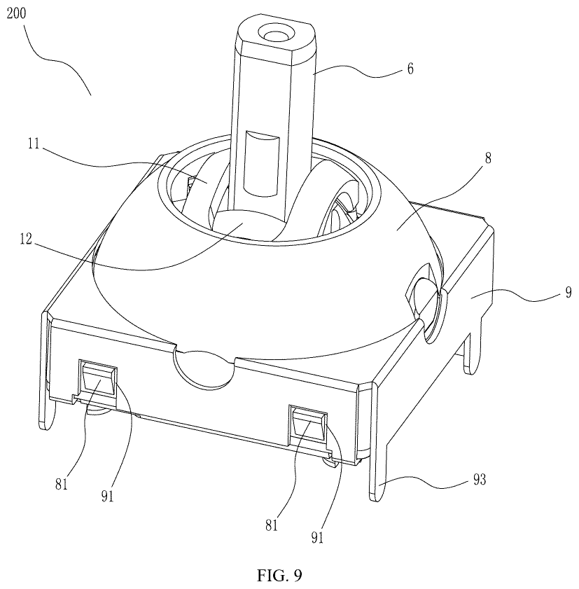

As shown in FIG. 8 to FIG. 12, an outside wall of the upper cover 8 is provided with multiple latch blocks 81, a side of the housing 9 defines multiple latch grooves 91 corresponding to the latch blocks 81 respectively, and the latch grooves 91 are in snap fit with the latch blocks 81 respectively. The lower end of the housing 9 is provided with four locking tabs 92 bent inwardly and four connecting pins 93 extending downwardly, and the locking tabs 92 are attached onto the lower side of the base 3 and are hooked onto the base 3. Each joystick mechanism installation position 1 defines four inserting holes 101, and the connecting pins 93 of the housing 9 are inserted into and connected to the inserting holes 101 correspondingly. Furthermore, the housing 9 is a metal housing, a lower end of the base 3 is provided with four positioning columns 35, each joystick mechanism installation position 1 defines four positioning holes 102, and the positioning columns 35 are inserted into and connected to the positioning holes 102 respectively.

As shown in FIG. 7 to FIG. 12, the upper rocker arm 11 includes an upper rocker arm body 111 and upper rocker arm pivot shafts 112. The upper rocker arm pivot shafts 112 are connected to two ends of the upper rocker arm body 111 and are rotatably connected to an inner wall of the upper cover 8, a central part of the upper rocker arm body 111 defines an upper rocker arm central hole 114 which allows the joystick 6 to pass therethrough movably, a lower end of one of the upper rocker arm pivot shafts 112 is provided with a first magnet positioning block 113, and the first permanent magnet 15 is installed in the first magnet positioning block 113 and is vertically opposite to the first magnetic induction chip 13.

As shown in FIG. 7 to FIG. 12, the lower rocker arm 12 includes a lower rocker arm body 121 and lower rocker arm pivot shafts 122. The lower rocker arm pivot shafts 112 are connected to two ends of the lower rocker arm body 121 and are rotatably connected to an inner wall of the upper cover 8. A central part of the lower rocker arm body 121 defines a lower rocker arm central hole 123 which allows the joystick 6 to pass therethrough movably, and an inner wall of the lower rocker arm body 121 surrounding the lower rocker arm central hole 123 is rotatably connected to the joystick 6. A lower end of one of the lower rocker arm pivot shafts 122 is provided with a second magnet positioning block 124, and the second permanent magnet 16 is installed in the second magnet positioning block 124 and is vertically opposite to the second magnetic induction chip 14. A lower end of another one of the lower rocker arm pivot shafts 122 is provided with a pressure block 125, each joystick mechanism installation position 1 is provided with a dome switch 11, and the pressure block 125 is in pressing engagement with the dome switch 11. An end of the base 3 defines a pressure block through hole 36 penetrating up and down, and the pressure block 125 extends downwardly into the pressure block through hole 36. The dome switch 11 is disposed on the handle circuit board 100 through soldering, and can be installed by the SMT process for easy manufacturing. Meanwhile, in the disclosure, there is no need to arrange a circuit board for installing the dome switch 11 in each joystick mechanism 200, significantly simplifying the assembly and manufacturing process of the joystick mechanisms 200.

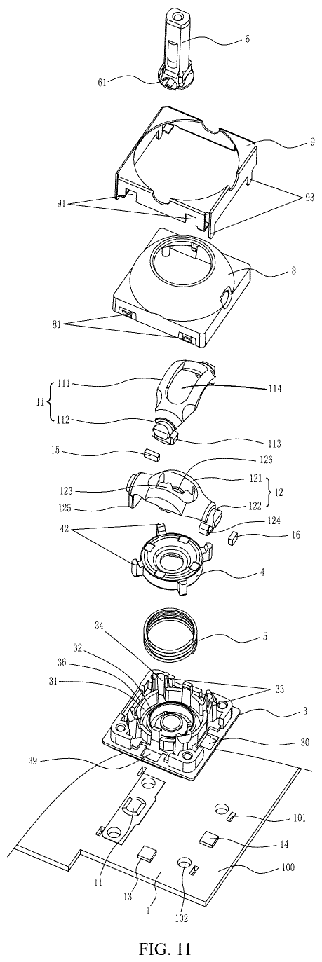

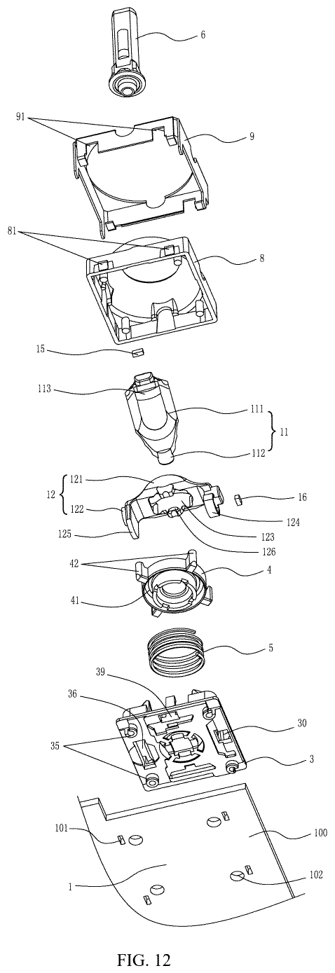

As shown in FIG. 11 and FIG. 12, the inner wall of the lower rocker arm body 121 surrounding the lower rocker arm central hole 123 is provided with a locking block 126, a side wall of the lower end of the joystick 6 defines a locking hole 61, and the locking block 126 is rotatably engaged with the locking hole 61.

The above is only the illustrated embodiments of the disclosure. Any minor modifications, equivalent changes, and modifications made to the above embodiments based on the technical solution of the disclosure are within the scope of the technical solution of the disclosure.

What is claimed is:

1. A split-type electromagnetic induction joystick potentiometer, comprising:
a handle circuit board, provided with at least one joystick mechanism installation position, wherein each of the at least one joystick mechanism installation position is welded with a magnetic induction chip; and
at least one joystick mechanism, installed on the at least one joystick mechanism installation position respectively, wherein each of the at least one joystick mechanism comprises a base, a sliding disc, a spring, a joystick, a rocker arm, an upper cover and a housing;
wherein the base defines a cavity, the sliding disc is installed in a liftable manner inside the cavity, the base is provided with a cavity spring seat on an outer periphery of the cavity, and a lower side of the sliding disc is provided with a sliding disc spring seat; a lower end of the spring is installed on the cavity spring seat, and an upper end of the spring is installed under the sliding disc spring seat; the base is connected to guide pins on sides of the cavity, walls of the guide pins facing towards the cavity define guide grooves respectively, sides of the sliding disc are connected to guide strips, and the guide strips correspond to and are in sliding fit with the guide grooves respectively; the joystick is installed on the sliding disc, a lower end of the joystick is installed with a permanent magnet, and the permanent magnet interacts magnetically with the magnetic induction chip; the upper cover is installed on the base, the rocker arm is installed inside the upper cover, and the joystick passes through the upper cover and is connected to the rocker arm; and the housing is installed outside the base and the upper cover, a lower end of the housing is connected to the base and the handle circuit board individually, and an upper end of the housing is connected to the upper cover.

2. The split-type electromagnetic induction joystick potentiometer as claimed in claim 1, wherein an outside wall of the upper cover is provided with a plurality of latch blocks, a side of the housing defines a plurality of latch grooves corresponding to the plurality of latch blocks respectively, and the plurality of latch grooves are in snap fit with the plurality of latch blocks respectively; the lower end of the housing is provided with a plurality of locking tabs bent inwardly and a plurality of connecting pins extending downwardly, and the plurality of locking tabs are attached onto a lower side of the base and are hooked onto the base; and each of the at least one joystick mechanism installation position defines a plurality of inserting holes, and the plurality of connecting pins of the housing is inserted into and connected to the plurality of inserting holes correspondingly.

3. The split-type electromagnetic induction joystick potentiometer as claimed in claim 2, wherein the housing is a metal housing, a lower end of the base is provided with a plurality of positioning columns, each of the at least one joystick mechanism installation position defines a plurality of positioning holes, and the plurality of positioning columns are inserted into and connected to the plurality of positioning holes respectively.

4. The split-type electromagnetic induction joystick potentiometer as claimed in claim 1, wherein the rocker arm comprises a rocker arm body and rocker arm pivot shafts; the rocker arm pivot shafts are connected to two ends of the rocker arm body and are rotatably connected to an inner wall of the upper cover, a lower end of one of the rocker arm pivot shafts is provided with a pressure block, each of the at least one joystick mechanism installation position is provided with a dome switch, and the pressure block is in pressing engagement with the dome switch; a central part of the rocker arm body defines a rocker arm central hole allowing the joystick to pass therethrough, and an inner wall of the rocker arm body surrounding the rocker arm central hole is rotatably connected to the joystick; and an end of the base defines a pressure block through hole penetrating up and down, and the pressure block extends downwardly into the pressure block through hole.

5. The split-type electromagnetic induction joystick potentiometer as claimed in claim 4, wherein the inner wall of the rocker arm body surrounding the rocker arm central hole is provided with a locking block, a side wall of the lower end of the joystick defines a locking hole, and the locking block is rotatably engaged with the locking hole.

6. The split-type electromagnetic induction joystick potentiometer as claimed in claim 1, wherein the sliding disc defines a sliding disc central hole, the lower end of the joystick passes through the sliding disc central hole, the base defines a cavity central hole at a central part of the cavity, the sliding disc central hole is vertically opposite to the cavity central hole, an inner cover body is integrally formed and connected to the base inside the cavity central hole, a lower end of the inner cover body defines a chip accommodation groove, and an upper end of the magnetic induction chip is accommodated inside the chip accommodation groove.

7. The split-type electromagnetic induction joystick potentiometer as claimed in claim 1, wherein the permanent magnet is a cylindrical permanent magnet, the permanent magnet is vertically opposite to the magnetic induction chip, and an upper side of the inner cover body defines a clearance groove which is arc-shaped.

8. The split-type electromagnetic induction joystick potentiometer as claimed in claim 1, wherein a number of the at least one joystick mechanism installation position is two, and a number of the least one joystick mechanism is two.

9. A split-type electromagnetic induction joystick potentiometer, comprising:
a handle circuit board, provided with at least one joystick mechanism installation position, wherein each of the at least one joystick mechanism installation position is welded with a first magnetic induction chip and a second magnetic chip; and
at least one joystick mechanism, installed on the at least one joystick mechanism installation position respectively, wherein each of the at least one joystick mechanism comprises a base, a sliding disc, a spring, a joystick, an upper rocker arm, a lower rocker arm, an upper cover and a housing;
wherein the base defines a cavity, the sliding disc is installed in a liftable manner inside the cavity, the base is provided with a cavity spring seat on an outer periphery of the cavity, and a lower side of the sliding disc is provided with a sliding disc spring seat; a lower end of the spring is installed on the cavity spring seat, and an upper end of the spring is installed under the sliding disc spring seat; the base is connected to guide pins on sides of the cavity, walls of the guide pins facing towards the cavity define guide grooves respectively, sides of the sliding disc are connected to guide strips, and the guide strips correspond to and are in sliding fit with the guide grooves respectively; the joystick is installed on the sliding disc; the upper cover is installed on the base; the upper rocker arm and the lower rocker arm are installed inside the upper cover sequentially in that order from top to bottom, and the joystick passes through the upper cover and is connected to the upper rocker arm and the lower rocker arm; the base defines a first through hole and a second through hole penetrating up and down, an end of the upper rocker arm is provided with a first permanent magnet, an upper end of the first magnetic induction chip extends into the first through hole, and the first permanent magnet interacts magnetically with the first magnetic induction chip; an end of the lower rocker arm is provided with a second permanent magnet, an upper end of the second magnetic induction chip extends into the second through hole, and the second permanent magnet interacts magnetically with the second magnetic induction chip; and the housing is installed outside the base and the upper cover, a lower end of the housing is connected to the base and the handle circuit board individually, and an upper end of the housing is connected to the upper cover.

10. The split-type electromagnetic induction joystick potentiometer as claimed in claim 9, wherein an outside wall of the upper cover is provided with a plurality of latch blocks, a side of the housing defines a plurality of latch grooves corresponding to the plurality of latch blocks respectively, and the plurality of latch grooves are in snap fit with the plurality of latch blocks respectively; the lower end of the housing is provided with a plurality of locking tabs bent inwardly and a plurality of connecting pins extending downwardly, and the plurality of locking tabs are attached onto a lower side of the base and are hooked onto the base; and each of the at least one joystick mechanism installation position defines a plurality of inserting holes, and the plurality of connecting pins of the housing are inserted into and connected to the plurality of inserting holes correspondingly.

11. The split-type electromagnetic induction joystick potentiometer as claimed in claim 10, wherein the housing is a metal housing, a lower end of the base is provided with a plurality of positioning columns, each of the at least one joystick mechanism installation position defines a plurality of positioning holes, and the plurality of positioning columns are inserted into and connected to the plurality of positioning holes respectively.

12. The split-type electromagnetic induction joystick potentiometer as claimed in claim 9, wherein the upper rocker arm comprises an upper rocker arm body and upper rocker arm pivot shafts; the upper rocker arm pivot shafts are connected to two ends of the upper rocker arm body and are rotatably connected to an inner wall of the upper cover, a central part of the upper rocker arm body defines an upper rocker arm central hole which allows the joystick to pass therethrough movably, a lower end of one of the upper rocker arm pivot shafts is provided with a first magnet positioning block, and the first permanent magnet is installed in the first magnet positioning block and is vertically opposite to the first magnetic induction chip.

13. The split-type electromagnetic induction joystick potentiometer as claimed in claim 9, wherein the lower rocker arm comprises a lower rocker arm body and lower rocker arm pivot shafts; the lower rocker arm pivot shafts are connected to two ends of the lower rocker arm body and are rotatably connected to an inner wall of the upper cover; a central part of the lower rocker arm body defines a lower rocker arm central hole which allows the joystick to pass therethrough movably, and an inner wall of the lower rocker arm body surrounding the lower rocker arm central hole is rotatably connected to the joystick; a lower end of one of the lower rocker arm pivot shafts is provided with a second magnet positioning block, and the second permanent magnet is installed in the second magnet positioning block and is vertically opposite to the second magnetic induction chip; a lower end of another one of the lower rocker arm pivot shafts is provided with a pressure block, each of the at least one joystick mechanism installation position is provided with a dome switch, and the pressure block is in pressing engagement with the dome switch; and an end of the base defines a pressure block through hole penetrating up and down, and the pressure block extends downwardly into the pressure block through hole.

14. The split-type electromagnetic induction joystick potentiometer as claimed in claim 13, wherein the inner wall of the lower rocker arm body surrounding the lower rocker arm central hole is provided with a locking block, a side wall of the lower end of the joystick defines a locking hole, and the locking block is rotatably engaged with the locking hole.

15. The split-type electromagnetic induction joystick potentiometer as claimed in claim 9, wherein a number of the at least one joystick mechanism installation position is two, and a number of the least one joystick mechanism is two.
